(19) United States
(12) Patent Application Publication
(10) Pub. No.: US 2010/0173077 A1
(43) Pub. Date: Jul. 8, 2010

(54) Treating Fluids for Dye Based Inks

(76) Inventor: Yaqiang Ming, (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/345,139

(22) Filed: Dec. 29, 2008

(51) Int. Cl. B05D 1/36; C08K 3/22; C08L 79/00; C08L 39/08; C08L 39/02; C08L 33/26; C08L 29/04; C08L 39/06; C08L 1/00

(52) U.S. Cl. 427/261; 524/430; 524/612; 524/548; 524/555; 524/500; 524/503; 524/502; 524/35

(57) ABSTRACT

The present invention relates to a treating composition for improving print qualities interactions of dye based inks and recording media. The treating composition may be used to coat the recording media by a coater such as a roller, rod, size meter, etc. prior to jetting of the dye based inks onto the recording media, or the treating composition may be jetted on the recording media before, simultaneously, or soon after depositing dye based inks onto the recording media by an inkjet printer. The treating composition is comprised of a liquid medium, one or more cationic colloids, and one or more cationic polymers.

### CROSS-REFERENCE TO RELATED APPLICATION

Not applicable.

### MICROFICHE APPENDIX

Not applicable.

### GOVERNMENT RIGHTS IN PATENT

Not applicable.

### BACKGROUND OF THE INVENTION

1. Field of the Invention

The present invention relates generally to dye based inks, and more particularly relates to compositions and methods for treating and printing upon a recording substrate with a dye based ink to optimize color richness, black optical density, and water resistance.

2. Description of the Related Art

The printing quality of traditional inkjet printers is heavily dependent upon both the type of ink and type of paper upon which one is printing. Print properties of color richness (gamut), black optical density (L*min), dry time, water fastness, ink bleeding, and the like, change based upon the particular ink, particular paper, and combinations of the ink and paper interactions. As such, some ink and paper combinations provide excellent print qualities, while other ink and paper combinations provide poor print qualities.

Efforts have been made to improve the print quality of inkjet printers via modifications to the associated ink. For example, U.S. Pat. No. 5,198,023 to Stoffel and U.S. Pat. No. 6,814,793 to Akers et al. disclose means of reducing print bleed by using cationic dyes in the ink.

Other efforts have been made to improve print quality of inkjet printers via modifications to the associated paper or recording substrate. For example, U.S. Pat. No. 6,207,258 to Varnell describes incorporating divalent metal salts into the surface of paper.

Treating paper with a pre-ink coating such as, for example, a polyvalent metal solution or organic acid, to improve print quality has also been described in the prior art. Such treating may be very efficient to flocculate pigment based inks, especially self-dispersed pigment inks. However, such treating does not improve printing quality of dye based inks.

Cationic polymer solutions have been proposed to improve water resistance of dye based inks; however, such solutions do not improve color richness and black optical density of the dye based inks.

Thus, what is needed is a treating composition for improving the print qualities of dye based inks.

### SUMMARY

The various exemplary embodiments of the present invention include a treating composition for use with a dye based ink and a recording substrate. The treating composition is comprised of a liquid medium, one or more cationic colloids, and one or more cationic polymers.

The various exemplary embodiments of the present invention further include a method of printing on a recording substrate. The method is comprised of positioning the recording substrate adjacent to an ink print head having a dye based ink, jetting a treating composition filled in an ink-free cartridge on at least one side of the recording substrate, and depositing the dye based ink on the recording substrate jetted by the treating composition. The treating composition is comprised of a liquid medium, one or more cationic colloids, and one or more cationic polymers.

Other various exemplary embodiments of the present invention include a method of printing on a recording substrate. The method is comprised of coating the recording substrate with a treating composition, positioning the recording substrate adjacent to an ink print head having a dye based ink, and depositing the dye based ink on the recording substrate. The treating composition is comprised of a liquid medium, one or more cationic colloids, and one or more cationic polymers.

### DETAILED DESCRIPTION

The various exemplary embodiments of the present invention include a treating composition for use with a dye based ink and a recording substrate. The treating composition is comprised of a liquid medium, one or more cationic colloids, and one or more cationic polymers.

The liquid medium in the various exemplary embodiments of the present invention is preferably water. The recording substrate is preferably paper.

In the various exemplary embodiments, the one or more cationic colloids are about five to about sixty percent by weight of the treating composition, and preferably are alumina-based, silica-based, or a combination thereof.

The one or more cationic polymers of the various exemplary embodiments are up to about twenty percent by weight of the treating composition. Examples of the one or more cationic polymers include polyamines, quaternized polyamines, polyguanidines, polyethyleneimine, polyvinylpyridine, polyvinylamine, polyallyamine, poly (N,N-dimethyl 2-hydroxypropylene ammonium chloride), poly (4-vinyl 1-methyl-pyridinium bromide), polydiallydimethylammonium chloride, copolymers of quaternized vinylimidazole and polyquaternium, and combinations thereof.

Exemplary embodiments of the present invention further include one or more humectants, one or more surfactants, one or more polymer binders, and combinations thereof.

Examples of preferred polymer binders of the exemplary embodiments of the present invention include polyvinyl alcohol, polyvinyl pyrrolidone, cellulose, polyacrylamide, copolymers, and combinations thereof.

In other various embodiments, the treating composition of the present invention may further include one or more of a biocide, a buffer, a defoamer, and a viscosity control agent.

The treating composition according the various exemplary embodiments of the present invention may be jetted or coated upon at least one side of a recording substrate. In a preferred embodiment, the treating composition is jetted or coated upon the recording substrate prior to depositing of an associated dye based ink upon the same recording substrate. In exemplary embodiments, the treating composition may be jetted onto the recording substrate before, substantially at the same time, or immediately after one or more dye based inks are deposited onto the recording substrate.

The disclosure may be further illustrated by the following examples. It should be understood that the following example is not intended to limit the scope of the present invention.

### Example

Two treating compositions, Formulation A and Formulation B, were prepared according to Table 1 to illustrate the present invention. It should be appreciated that the present invention is not limited to the particular features of the two exemplary treating compositions illustrated in Table 1.

TABLE 1
Exemplary Treating Fluid Compositions to Illustrate the
Present Invention

Formulation

| | A (% wt) | B (% wt) |
|---|---|---|
| Water | 34.97 | 18.97 |
| Cab-O-Sphere PG003 (40%) | 50 | 50 |
| Glycerol | 0 | 20 |
| Kordex MLX ™ | 0.13 | 0.13 |
| Surfynol 465 ™ | 0.7 | 0.7 |
| Surfynol 440 ™ | 0.2 | 0.2 |
| VANTOCIL ® IB (20%) | 10 | 10 |
| MAGNAFLOC ® LT 7981 (50%) | 4 | 0 |

As illustrated in Table 1, each of Formulation A and Formulation B are comprised of about fifty percent of Cab-O-Sphere PG003, an alumina-based cationic colloid, and about ten percent of VANTOCIL® IB (available from Arch UK Biocides Limited), a cationic polymer. Formulation A is further comprised of MAGNAFLOC® LT 7981 (available from Ciba Speciality Chemicals Water Treatments Limited), a cationic polymer. Formulation B is also comprised of glycerol, a humectant.

The effect of Formulation A on commercially available plain paper substrates was examined. In particular, Formulation A was applied to HMLP paper by a #7 Meyer rod and air-dried prior to depositing dye based ink on the paper. The coated sheets of paper were printed by a LEXMARK® X9575 printer with color and black dye based inks at plain/normal (P/N) and plain/best (P/B) printing mode with a standard plain paper gamut file. The gamut and L*min were measured and given in Table 2. Water resistance was ranked on a scale of 1-5, wherein 1 is the best, and 5 is the worst.

TABLE 2
Effects of Formulation A on Gamut and L*min on
Plain Paper Substrate

| | No Treating | |
|---|---|---|
| | Composition | Formulation A |
| Gamut (P/N) | 176 | 245 |
| L*min (P/N) | 29.9 | 22.5 |
| Gamut (P/B) | 192 | 283 |
| L*min (P/N) | 29.3 | 22.4 |
| Water Resistance | 5 | 1 |

As illustrated in Table 2, there are improved gamut and L*min values when the treating composition, Formulation A, is coated on the plain paper substrate, as opposed to not coating the plain paper substrate with a treating composition according to the present invention.

The effect of Formulation B on various commercially available plain paper substrates was also examined. In particular, Formulation B was applied to various commercially available papers by a CANON® PIXMA® MX7600 pre-coat roller prior to depositing dye based ink on the paper. The coated and uncoated sheets of paper were printed with color and black dye based inks at plain/normal (P/N) and plain/best (P/B) printing mode with a standard plain paper gamut file. The gamut and L*min for the plain normal (P/N) printing mode were measured and given in Table 3. Water resistance was ranked on a scale of 1-5, wherein 1 is the best, and 5 is the worst.

TABLE 3
Effects of Formulation B on Gamut and L*min on Various Plain
Paper Substrates at P/N printing mode

| | | | | Water |
|---|---|---|---|---|
| Substrate | Coating | Gamut | L*min | Resistance |
| HMLP | None | 178 | 29.7 | 5 |
| (by International | Formulation B | 220 | 25.6 | 3 |
| Paper) | | | | |
| XX4200 | None | 165 | 28 | 5 |
| (by Xerox) | Formulation B | 202 | 25.1 | 3 |
| Printworks MP | None | 166 | 28.4 | 5 |
| (by Paris | Formulation B | 194 | 25.2 | 3 |
| Business | | | | |
| Products) | | | | |
| HP Multipurpose | None | 158 | 29.5 | 5 |
| (by Hewlett- | Formulation B | 202 | 25.4 | 3 |
| Packard) | | | | |
| Tidal MP | None | 159 | 27.9 | 5 |
| (by International | Formulation B | 202 | 25.1 | 3 |
| Paper) | | | | |
| Copy Plus | None | 157 | 29.1 | 5 |
| (by International | Formulation B | 199 | 25.4 | 3 |
| Paper) | | | | |
| Average of | None | 164 | 28.8 | 5 |
| above six papers | Formulation B | 203 | 25.3 | 3 |

The gamut and L*min for the plain best (P/B) printing mode were measured and given in Table 4.

TABLE 4
Effects of Formulation B on Gamut and L*min on Various Plain
Paper Substrates at P/B printing mode

| Substrate | Coating | Gamut | L*min |
|---|---|---|---|
| HMLP | None | 192 | 29.5 |
| (by International | Formulation B | 255 | 24.5 |
| Paper) | | | |
| XX4200 | None | 191 | 27.6 |
| (by Xerox) | Formulation B | 236 | 23.5 |
| Printworks MP | None | 188 | 27.5 |
| (by Paris | Formulation B | 221 | 24 |
| Business | | | |
| Products) | | | |
| HP Multipurpose | None | 184 | 28.2 |
| (by Hewlett- | Formulation B | 236 | 24.5 |
| Packard) | | | |
| Tidal MP | None | 185 | 27.1 |
| (by International | Formulation B | 235 | 24.9 |
| Paper) | | | |
| Copy Plus | None | 182 | 28.4 |
| (by International | Formulation B | 229 | 24.7 |
| Paper) | | | |
| Average of | None | 187 | 28.1 |
| above six papers | Formulation B | 235 | 24.4 |

As illustrated in Tables 3 and 4, there are improved gamut and L*min values when the treating composition, Formulation B, is coated on the plain paper substrate, as opposed to not coating the plain paper substrate with a treating composition according to the present invention.

Thus, as can therefore be seen from the above, the present disclosure provides a treating composition that, when used in conjunction with a recording substrate and dye based ink, provides a more desired gamut, L*min, and water resistance than the same recording substrate and dye based ink without the presently claimed treating composition.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A treating composition for use with a dye based ink and a recording substrate, the treating composition being comprised of:
a liquid medium;
one or more cationic colloids; and
one or more cationic polymers.

2. The treating composition according to claim 1, wherein the one or more cationic colloids are alumina-based, silica-based, or a combination thereof.

3. The treating composition according to claim 1, wherein the one or more cationic colloids are about 5 to about 60% of the treating composition by weight.

4. The treating composition according to claim 1, wherein the one or more cationic polymers are of polyamines, quaternized polyamines, polyguanidines, polyethyleneimine, polyvinylpyridine, polyvinylamine, polyallyamine, poly (N,N-dimethyl 2-hydroxypropylene ammonium chloride), poly (4-vinyl 1-methyl-pyridinium bromide), polydiallydimethylammonium chloride, copolymers of quaternized vinylimidazole and polyquaternium, or a combination thereof.

5. The treating composition according to claim 1, wherein the one or more cationic polymers are up to about 20% of the treating composition by weight.

6. The treating composition according to claim 1, wherein the liquid medium is water.

7. The treating composition according to claim 1, further comprising one or more humectants.

8. The treating composition according to claim 1, further comprising one or more surfactants.

9. The treating composition according to claim 1, further comprising one or more polymer binders.

10. The composition of claim 9 wherein said polymer binder is selected from the group consisting of polyvinyl alcohol, polyvinyl pyrrolidone, cellulose, polyacrylamide, copolymers, and combinations thereof.

11. The treating composition according to claim 1, further comprising a biocide, a buffer, a defoamer, and a viscosity control agent.

12. A method of printing on a recording substrate, the method being comprised of the steps of:
positioning the recording substrate adjacent to an ink print head having one or more dye based inks;
jetting a treating composition filled in an ink-free cartridge on at least one side of the recording substrate, wherein the treating composition is comprised of a liquid medium; one or more cationic colloids; and one or more cationic polymers; and
depositing the one or more dye based inks on the recording substrate.

13. The method according to claim 12, wherein the one or more cationic colloids are alumina-based, silica-based, or a combination thereof.

14. The method according to claim 12, wherein the one or more cationic polymers are polyamines, quaternized polyamines, polyguanidines, polyethyleneimine, polyvinylpyridine, polyvinylamine, polyallyamine, poly (N,N-dimethyl 2-hydroxypropylene ammonium chloride), poly (4-vinyl 1-methyl-pyridinium bromide), polydiallydimethylammonium chloride, copolymers of quaternized vinylimidazole and polyquaternium, or a combination thereof.

15. The method according to claim 12, wherein the step of jetting of the treating composition may occur before, substantially at the same time, or immediately after the step of depositing of the one or more dye based inks on the recording substrate.

16. A method of printing on a recording substrate, the method being comprised of the steps of:
coating the recording substrate with a treating composition, wherein the treating composition is comprised of a liquid medium; one or more cationic colloids; and one or more cationic polymers;
positioning the recording substrate adjacent to an ink print head having one or more dye based inks;
depositing the one or more dye based inks on the recording substrate.

17. The method according to claim 16, wherein the one or more cationic colloids are alumina-based, silica-based, or a combination thereof.

18. The method according to claim 16, wherein the one or more cationic polymers are polyamines, quaternized polyamines, polyguanidines, polyethyleneimine, polyvinylpyridine, polyvinylamine, polyallyamine, poly (N,N-dimethyl 2-hydroxypropylene ammonium chloride), poly (4-vinyl 1-methyl-pyridinium bromide), polydiallydimethylammonium chloride, copolymers of quaternized vinylimidazole and polyquaternium, and combinations thereof.

19. The method according to claim 16, wherein the step of coating the treating composition further includes employment of one or more rods, one or more rollers, one or more size presses, or the like.
